(19) United States
(12) Patent Application Publication
(10) Pub. No.: US 2004/0142199 A1
(43) Pub. Date: Jul. 22, 2004

(54) Composite material for a sliding bearing comprising a metallic support layer

(76) Inventors: Wolfgang Bickle, Reilingen (DE); Werner Schubert, Wiesloch (DE); Thomas Storch, Bruehl (DE)

Correspondence Address: Paul J Vincent, Dreiss Fuhlendorf Steimle & Becker, Postfach 10 37 62, Stuttgart, D-70032, DE

(21) Appl. No.: 10/478,256

(22) PCT Filed: May 31, 2002
(86) PCT No.: PCT/EP02/05995

(30) Foreign Application Priority Data
May 31, 2001 (DE) 101 26 460.7

(51) Int. Cl. B32B 15/08; F16C 33/20

(52) U.S. Cl. 428/553; 384/902; 384/908; 384/910; 428/421

(57) ABSTRACT

The invention relates to a composite material for a sliding bearing comprising a metallic support layer, a porous carrier layer applied thereon and a PTFE-based sliding layer that forms a sliding surface for a sliding partner. Said material is characterised in that the material that forms the sliding layer also fills the pores of the carrier layer and contains at least 65 vol. % PTFE and 10-25 vol. % zinc sulphide. In order to provide a high degree of wear resistance with a low friction coefficient, the material of the sliding layer contains in addition 1.5-3.5 vol. % carbon fibers and 3-7 vol. % PPSO₂.

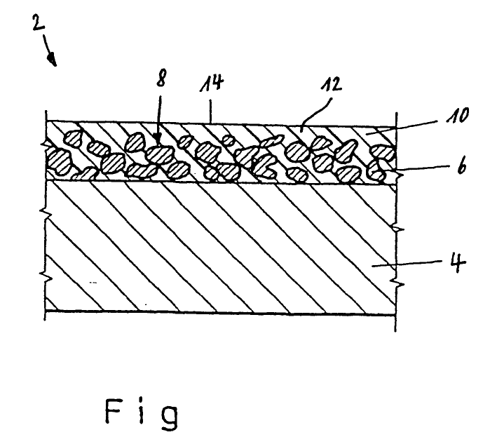

The invention concerns a sliding bearing composite material with a metallic support layer, a porous carrier layer disposed thereon, and a sliding layer on the basis of PTFE which forms a sliding surface for a sliding partner, wherein the material forming the sliding layer also fills the pores of the carrier layer and comprises at least 60 percent by volume of PTFE and 10-25 percent by volume of zinc sulfide.

A sliding bearing composite material of this type is disclosed e.g. in EP 0 232 922 B1. However, this document does not mention a minimum content of 60 percent by volume of PTFE. For a long time, the Assignee has been producing a sliding bearing composite material which consists of 75 percent by volume of PTFE and 25 percent by volume of ZnS. This patent document also mentions that 5 to 40 percent by volume of aramide fibers, carbon fibers, and/or glass fibers may be additionally contained as fillers.

EP 0 708 892 B1 discloses a sliding bearing composite material which does not disclose all the features characterizing the invention, whose sliding layer material comprises PTFE and 2 to 20 percent by volume of fibrillated aramide fibers. In addition to PTFE, the embodiments also comprise PPS, PFA or calcium fluoride in various proportions. This document does not provide any additional substantive information.

WO 99/45285 discloses a sliding bearing composite material which does not disclose all the features characterizing the invention, whose sliding layer material preferably comprises PTFE, 10 to 30 percent by volume of a metal fluoride, in particular calcium fluoride, 2 to 10% of fibrillated aramide fibers, and 2 to 10% of a meltable fluoropolymer, FEP, PFA or MFA, wherein FEP is preferred. A detailed embodiment is disclosed comprising 4 percent by volume of aramide fibers, 7 percent by volume of FEP, 18 percent by volume of CaF, the rest being PTFE.

WO 99/01675 discloses a sliding bearing composite material whose sliding bearing material comprises at least 60 percent by volume of PTFE, 15 to 25 percent by volume of a metallic filler, preferably lead, preferably 8 to 12 percent by volume of PVDF, and 1 to 3 percent by volume of carbon fibers, oriented in a preferred direction. The use of metallic fillers, in particular lead, has become increasingly unacceptable.

DE 693 27 377 T2 discloses a sliding bearing composite material with metallic support layer, a porous carrier layer and a sliding layer, wherein the main component of the sliding layer material is PTFE. Moreover, zinc oxide whiskers and magnesium oxysulfate are provided to improve the poor wear resistance of PTFE. Zinc sulfide is mentioned in one embodiment in addition to a large number of other components. One single embodiment contains PFA in the following combination: 65% by weight of PTFE, 15% by weight of zinc oxide whisker, 5% by weight of MgO and 20% by weight of PFA.

DE 33 43 697 A1 also discloses a sliding bearing composite material with a support layer, a carrier layer and a sliding layer whose sliding layer material comprises a mixture of the following components: 0.1 to 50 percent by volume of at least one substance of solid lubricants such as metallic lubricants with low melting point, e.g. Pb, Sn or alloys thereof, metal oxides, metal sulfides, metal fluorides, graphite or the like, fibrous materials such as carbon fibers and ceramics such as SiC, the rest being substantially PTFE, wherein the total amount of substance content other than PTFE is within a range of 0.2 to 70 percent by volume.

DE 197 45 667 A1 discloses a polymeric coating system which can also be used for sliding layer applications. It discloses compositions with less than 40% by weight of PTFE, more than 30% by weight of PFA, 10 or 20% by weight of PAI, and 2.5, 5, 10 or 20% by weight of PPSO₂.

DE 197 28 131 A1 discloses an implantation bearing for artificial joint replacement in humans, wherein PPSO₂ is e.g. suggested as the filler of a base polymer. PTFE is not mentioned as a base polymer.

DE 196 54 102 A1 describes polymeric fluoric mixtures with PTFE and PPSO₂. Sliding bearing applications are not mentioned.

In view of the above, it is the object of the present invention to produce a sliding bearing composite material of the above-mentioned type which has both a high wear resistance and a low coefficient of friction.

This object is achieved in accordance with the invention with a sliding bearing composite material of this kind in that the sliding layer material further comprises 1.5 to 3.5 percent by volume of carbon fibers and 3-7percent by volume of PPSO₂.

The goals of increasing the wear resistance and maintaining a low coefficient of friction to thereby achieve suitable tribological properties actually constitute contradictory objectives. A sliding bearing composite material on the basis of PTFE only has e.g. an excellent coefficient of friction, but the wear resistance is unsatisfactory, although it can be improved by adding fillers, e.g. metallic fillers. The metallic fillers improve heat dissipation thereby keeping the operating temperatures low to thereby increase the wear resistance.

Moreover, as mentioned above, the addition of fibrous fillers, in particular carbon fibers, is known to increase the coefficient of friction. A high carbon fiber portion, in particular 4 percent by volume and more, increases the wear resistance, but severely impairs the coefficient of friction. Moreover, the addition of fibrous fillers has the disadvantage that the fibers cannot be held or anchored easily in the sliding layer material and represent potential fatigue locations. For this reason, the above- mentioned document WO 99/45285 has proposed the use of so-called “fibrillated” aramide fibers which are better integrated in the sliding layer material due to their greatly increased surface area.

The present invention has shown that optimum results are obtained when the carbon fiber portion is at most 3.5% per volume and if 3 to 7% per volume of PPSO₂ is also contained in the sliding layer material. It has turned out that adding PPSO₂ as an additional PTFE-wear resistant component, in addition to the carbon fibers, reduces wear i.e. increases the wear resistance.

In accordance with the invention, a sliding layer material is produced which has a high wear resistance despite the relatively low carbon fiber portion of at most 3.5% per volume, in particular between 1.5 and 3.5% per volume, through adding PPSO₂.

In accordance with a further embodiment of the invention, the sliding layer material comprises 3-6, preferably 4-6% per volume of PPSO_{2.}

Optimum properties of the sliding layer material in view of a maximized wear resistance while maintaining a good frictional value are obtained with a carbon fiber portion of 2.5 to 3.5% per volume.

Carbon fibers of a thickness of 10-20 μm, in particular 10-16 μm and particularly preferred 12-16 μm are preferably used. The length of the carbon fibers is in particular 100-250 μm, preferably 100-200 μm and particularly preferred 100-160 μm. When the fibers are too long, it is difficult to introduce the fibers into the pores of the carrier layer. When the fibers are too short, they do not contribute to the stability and anchoring in the matrix material is deteriorated.

The sliding layer material preferably comprises 65 to 85% by volume of PTFE, in particular 70 to 77% by volume of PTFE.

In accordance with a further embodiment of the invention, the zinc sulfide portion is 15 to 20% by volume.

The average grain size of the zinc sulfide particles used, measured in the centrifugal method according to DIN ISO 9001, is advantageously smaller than 1 μm, preferably between 0.2 and 0.5 μm. It has turned out that the addition of zinc sulfide supports separation and therefore homogeneous mixing of carbon fibers with the further components. One can see under the microscope that the fine zinc sulfide particles are disposed on or adhere in a quasi wetting fashion to the surface of the carbon fibers. This improves the homogeneous distribution and individual embedding of the carbon fibers in the matrix compound. It also shows that the use of fine-core zinc sulfide particles reduces the tendency of the composite material to swell during use.

Further features, details and advantages of the invention can be extracted from the claims and the following description and drawing of a preferred embodiment of the inventive sliding bearing composite material.

The figure shows a sliding bearing composite material, generally referred to with reference numeral 2, comprising a metallic support layer 4 of steel and a porous carrier layer 6 disposed thereon, preferably of a lead-free bronze layer, e.g. with 90 percent by weight of copper and 10 percent by weight of zinc. A sliding layer material 10 is introduced into the pores of the carrier layer 6 on the upper side 8 of the carrier layer 6 opposite the support layer 4. The sliding layer material 10 projects slightly past the upper side 8 of the carrier layer 6 and forms a sliding layer 12 with a sliding surface 14 for a sliding partner (not shown). The sliding layer material 10 has a PTFE matrix with at least 60 percent by volume of PTFE and 10 to 25 percent by volume of zinc sulfide and, in accordance with the invention, 1.5 to 3.5 percent by volume of carbon fibers and 3 to 7 percent by volume of PPSO₂.

A preferred composition of the sliding layer material comprises 65 to 85 percent by volume of PTFE forming the matrix, 10 to 25 percent by volume of ZnS, 1.5 to 3.5 percent by volume of carbon fibers and 3 to 7 percent by volume of PPSO₂. The sliding layer material preferably consists of the above-mentioned components.

A preferred exemplary composition contains 72 percent by volume of PTFE, 20 percent by volume of ZnS, 3 percent by volume of carbon fibers and 5 percent by volume of PPSO₂.

1. Sliding bearing composite material (2) with a metallic support layer (4), a porous carrier layer (6) disposed thereon, and a sliding layer (12) on the basis of PTFE which forms a sliding surface (14) for a sliding partner, wherein the sliding layer material (10) forming the sliding layer (12) also fills the pores of the carrier layer (6) and comprises at least 65 percent by volume of PTFE and 10 to 25 percent by volume of zinc sulfide, characterized in that the sliding layer material (10) also comprises 1.5-3.5 percent by volume of carbon fibers and 3-7 percent by volume of PPSO₂.

2. Sliding bearing composite material (10) according to claim 1, characterized in that the sliding layer material comprises 4-6 percent by volume of PPSO₂.

3. Sliding bearing composite material, characterized in that the sliding layer material comprises 2.5 to 3.5 percent by volume of carbon fibers.

4. Sliding bearing composite material, characterized in that the sliding layer material comprises 65-85 percent by volume of PTFE.

5. Sliding bearing composite material according to claim 4, characterized in that the sliding layer material comprises 70 to 77% by volume of PTFE.

6. Sliding bearing composite material, characterized in that the sliding layer material comprises 15-22 percent by volume of zinc sulfide.

7. Sliding bearing composite material according to any one or more of the preceding claims, characterized in that it contains zinc sulfide particles of an average core size of <1 μm.

8. Sliding bearing composite material according to claim 7, characterized in that it contains zinc sulfide particles of an average core size of 0.2 to 0.5 μm.

9. Sliding bearing composite material according to one or more of the preceding claims, characterized in that the thickness of the carbon fibers is 10-20 μm, in particular 10-16 μm.

10. Sliding bearing composite material according to any one or more of the preceding claims, characterized in that the length of the carbon fibers is 100-250 μm, preferably 100-200 μm, in particular 100-160 μm. 160 μm.
